(19) United States
(12) Patent Application Publication
(10) Pub. No.: US 2010/0283990 A1
(43) Pub. Date: Nov. 11, 2010

(54) Optoelectronic distance measuring device

(76) Inventors: Dezhong Yang, Nanjing (CN); Wu Chen, Nanjing (CN)

Correspondence Address: MCDERMOTT, WILL & EMERY LLP;Attn: IP Department, 227 WEST MONROE STREET, SUITE 4400, CHICAGO, IL, 60606-5096, US

(21) Appl. No.: 12/799,825

(22) Filed: May 3, 2010

(30) Foreign Application Priority Data
May 7, 2009 (CN) 200910027471.0

(51) Int. Cl. G01C 3/08

(52) U.S. Cl. 356/5.1

(57) ABSTRACT

The optoelectronic distance measuring device of the present invention comprises a signal generator for generating a high frequency signal, an emitter for emitting an optical beam signal towards an object to be measured, a photoelectric receiving and transforming device for receiving the reflected measuring optical and for generating a corresponding high frequency reflected measuring signal. The present invention further comprises a phase detector for performing a frequency mixing of signals and a signal processing device connected with the phase detector for determining the measured distance.

### CROSS-REFERENCE TO RELATED APPLICATIONS

This application claims priority under 35 U.S.C. §119 to CN 200910027471.0 filed May 7, 2009, which is hereby incorporated by reference.

FEDERALLY SPONSORED RESEARCH OR DEVELOPMENT

Not Applicable.

### TECHNICAL FIELD

The present invention relates to an optoelectronic distance measuring device, in particular to a phase-type optoelectronic distance measuring device.

### BACKGROUND OF THE INVENTION

An optoelectronic distance measuring device such as a laser phase measuring instrument is widely used in the fields of architecture, indoor decoration and the like because of its high level of measuring accuracy. The general principle behind the measurement is that an emitter emits a modulated measuring optical beam to an object to be measured, an optoelectronic receiver receives the reflected modulated measuring optical beam reflected by the measured object, and a distance from the measuring instrument to the object is determined by calculating the difference between the phase of the emitted signals of the modulated measuring optical beam and the phase of the received modulated measuring optical beam.

FIG. 1 shows a circuit diagram of an optoelectronic distance measuring device incorporating the principles of phase measuring. A phase-locked loop (PLL) circuit 11′ generates a mixed frequency signal and an initial frequency signal having the same frequency and the same phase. The initial frequency signal and a low frequency signal generated by a microcontroller unit (MCU) 12′ when modulated by a quadrature modulator 13′form a frequency modulated signal from which a frequency modulated signal is transmitted. The frequency modulated signal is amplified by a power amplifier 14′ and then transmitted to a laser emitter 15′ for frequency modulating. The emitter 15′ emits the modulated measuring optical beam to an object 16′ to be measured. An avalanche photodiode 17′ receives the modulated measuring optical beam reflected from the measured object 16′, and acts as a direct mixer. The mixed frequency signal and the reflected modulated measuring optical beam are mixed in the avalanche photodiode 17′. A resultant output signal from the avalanche photodiode 17′ is amplified by a transimpedance amplifier 18′ and filtered by a low pass filter 19′ to generate a low frequency signal. The phase information contained in the low frequency signal is then used to calculate the measured distance.

One problem with the prior art phase-type optoelectronic distance measuring device described above is that the additional frequency signals generated simultaneously with the initial frequency and low frequency signals are modulated to be a frequency modulated signal in the quadrature modulator 13′. These additional frequency signals may cause a beat interference in the circuit board of the optoelectronic distance measuring device and cause electrical interference between the electrical elements. The interference may then reduce the measuring ability of the optoelectronic distance measuring device.

### SUMMARY OF THE INVENTION

It is the object of the present invention to provide an optoelectronic distance measuring device with low signal interference and a high measuring capability, in order to overcome the disadvantages of the prior art.

Accordingly, the optoelectronic distance measuring device of the present invention comprises a signal generator for generating a high frequency signal fH, an emitter for emitting an optical beam modulated by the high frequency signal fH towards an object, a photoelectric receiving and transforming device for receiving the reflected measuring optical beam and for generating a corresponding high frequency reflected measuring signal fH′. The present invention further comprises a phase detector for performing a frequency mixing of signals and a signal processing device connected with the phase detector for determining the measure distance. In the present invention, the signal generator may be connected to the phase detector and the high frequency signal fH may be provided to the phase detector and mixed with the high frequency reflected measuring signal fH′ to generate a direct current signal which contains phase information for determining the measured distance. Ideally, the high frequency signal fH and the high frequency reflected measuring signal fH′ of the present invention would then have the same frequency and different phases.

Because the high frequency signal fH of the optoelectronic distance measuring device in the present invention has the same frequency as the high frequency reflected measuring signal fH′, the mixing of the signal to generate a direct current signal does not require any additional frequency signals to be generated. This efficiency helps prevent beat interference in the circuit board and electrical interference between the electrical elements of the optoelectronic distance measuring device. Further, the high frequency signal containing the phase information of the measured distance is processed into the low frequency signal with the phase information of the distance to be measured, thereby avoiding processing issues like noise. Moreover, the optoelectronic distance measuring device disclosed in the invention can be implemented without a separate device for frequency modulating, which greatly simplifies the structure of the measuring device, and reduces the costs of manufacturing.

### BRIEF DESCRIPTION OF THE DRAWINGS

The details of the present invention are described below in conjunction with accompanied drawings and embodiments.

FIG. 1 is a circuit diagram of an optoelectronic distance measuring device based on the principle of phase measuring in the prior art; and

FIG. 2 is a diagram of a preferred embodiment of an optoelectronic distance measuring device according to the present invention.

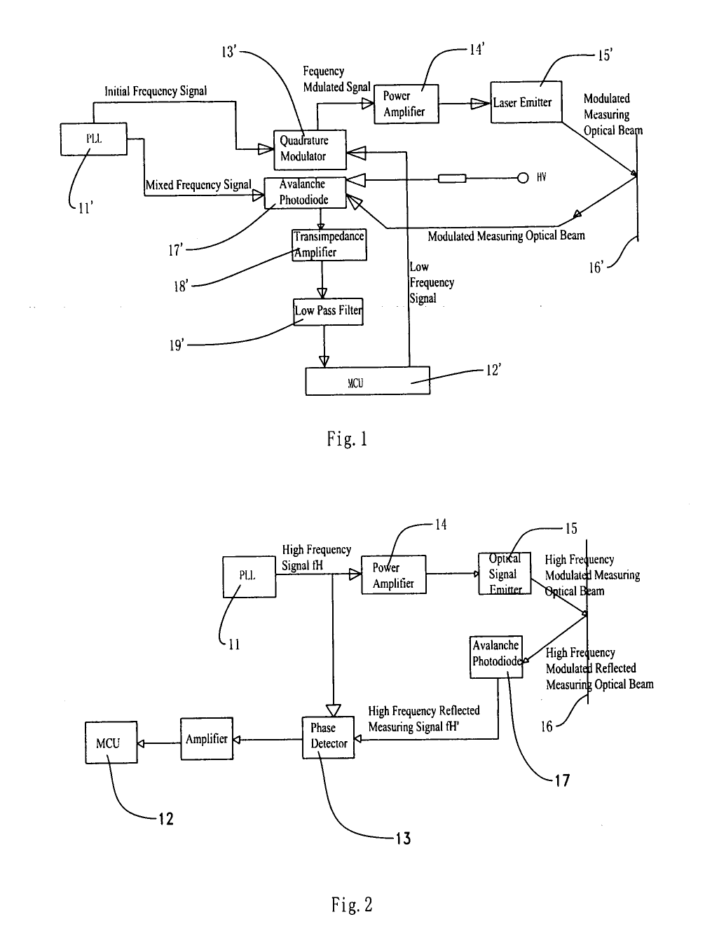

### DETAILED DESCRIPTION

Now referring to FIG. 2, according to a preferable embodiment of the invention, an optoelectronic distance measuring device comprises a phase-locked loop (PLL) circuit 11, a phase detector 13, an optical signal emitter 15, an avalanche photodiode 17 and a microcontroller unit (MCU) 12. The phase-locked loop (PLL) circuit 11 is directly connected to the phase detector 13 via an electrical line, and connected to the optical signal emitter 15 through a power amplifier 14. The microcontroller unit (MCU) 12 is connected to the phase detector 13 through an electrical line. The avalanche photodiode 17 is utilized for receiving optical measuring signals and transforming them into electrical measuring signals. The avalanche photodiode 17 is generally connected to a variable bias voltage through a series-connected resistance. The phase detector 13 may be used as a mixer for performing frequency mixing of signals.

The phase-locked loop (PLL) circuit 11 generates a high frequency signal fH which is inputted into the power amplifier 14 through an electrical line to be amplified and transferred to the emitter 15. The emitter 15 performs high frequency modulation to create a measuring optical beam. The emitter 15 may be any well known laser diode that is commercially available. The high frequency modulated measuring optical beam is then emitted towards an object 16 to be measured. The avalanche photodiode 17 receives the high frequency modulated measuring optical beam reflected from the object 16 to be measured, and generates a corresponding high frequency reflected measuring signal fH′ which has the same frequency and a different phase relative to the high frequency signal fH. Both the high frequency signal fH and the high frequency reflected measuring signal fH′ are inputted into the phase detector 13 through separate electrical lines. The high frequency signal fH and the high frequency reflected measuring signal fH′, having the same frequency and different phase, are mixed by the phase detector 13 and a resultant direct current signal containing phase information for determining distance to be measured is produced. The direct current signal is then input into the MCU 12 for processing. As a result, measured distance between the optoelectronic distance measuring device and the object to be measured may be obtained. The MCU 12 may also be connected to a display device. The MCU 12, using the display device, is able to display the measurement and other similar information.

The above description only describes the circuitry of the optoelectronic distance measuring device. This circuitry may be incorporated with any optical parts or receiving parts known to those in the relevant art.

The embodiment described above is only explanation for concepts and principles of the present invention without intending to limit the contents of the invention. Those of ordinary skill in the art may envision various obvious modifications without departing from the present invention which will be regarded as falling within the scope of this invention.

What is claimed is:

1. An optoelectronic distance measuring device, comprising:
a signal generator for generating a high frequency signal;
an emitter for emitting an optical beam, which is frequency-modulated by the high frequency signal;
a photoelectric receiving and transforming device for receiving the reflected measuring optical beam reflected from an object and generating a corresponding high frequency reflected signal;
a phase detector for mixing the high frequency signal and the high frequency reflected signal to generate a direct current signal containing phase information for determining a measured distance; and,
a signal processing device connected to the phase detector for calculating the measured distance.

2. The optoelectronic distance measuring device according to claim 1, wherein the signal generator is connected to the phase detector.

3. The optoelectronic distance measuring device according to claim 1, wherein the high frequency signal and the high frequency reflected signal have a same frequency and a different phase.

4. The optoelectronic distance measuring device according to claim 1, wherein the signal generator is phase-locked loop circuit.

5. The optoelectronic distance measuring device according to claim 1, wherein the emitter is a laser diode.

6. The device for optoelectronic distance measuring device according to claim 1, wherein a power amplifier is connected between the signal generator and the emitter.

7. The optoelectronic distance measuring device according to claim 1, wherein the photoelectric receiving and transforming device is an avalanche photodiode.

8. An optoelectronic distance measuring device, comprising:
a signal generator for generating a high frequency signal, wherein the signal generator is phase-locked loop circuit;
an emitter for emitting an optical beam, which is frequency-modulated by the high frequency signal, wherein the emitter is a laser diode;
a power amplifier connected between the signal generator and the emitter;
a photoelectric receiving and transforming device for receiving the reflected measuring optical beam reflected from an object and generating a corresponding high frequency reflected signal, wherein the photoelectric receiving and transforming device is an avalanche photodiode and the high frequency signal and the high frequency reflected signal have a same frequency and a different phase;
a phase detector for mixing the high frequency signal and the high frequency reflected signal to generate a direct current signal containing phase information for determining a measured distance, wherein the phase detector is connected to the signal generator; and,
a signal processing device connected to the phase detector for calculating the measured distance.
